(19) United States
(12) Patent Application Publication
(10) Pub. No.: US 2004/0195248 A1
(43) Pub. Date: Oct. 7, 2004

(54) Liquid applicator and container system

(76) Inventor: Nicolas Garcia, Alhambra, CA (US)

Correspondence Address: CHRISTIE, PARKER & HALE, LLP, PO BOX 7068, PASADENA, CA, 91109-7068, US

(21) Appl. No.: 10/820,076

(22) Filed: Apr. 7, 2004

Related U.S. Application Data
(60) Provisional application No. 60/461,305, filed on Apr. 7, 2003.
(60) Provisional application No. 60/469,672, filed on May 12, 2003.

(51) Int. Cl. B05C 21/00

(52) U.S. Cl. 220/570

(57) ABSTRACT

A painting container having a first cavity adapted to receive a painting utensil and a second cavity adapted to receive liquid to be applied to a surface with the painting utensil. A handle extends in the direction of the cavity is attached to the container that permits a user to grasp the handle while using the container for applying liquid to a surface. The handle is also dimensioned so as to allow the painting container to be mounted on a ladder. In one embodiment, the container is adapted to receive a liner and in one embodiment, the liner can be configured to have a roller tray to permit use of the container with roller application of paint or liquid to a surface. In another embodiment, the container is dimensioned so as to fit on a painting supply container to permit the container to reseal a painting supply container.

### CROSS-REFERENCE TO RELATED APPLICATION(S)

This application claims the benefit of U.S. Provisional application Serial Nos. 60/461,305 filed Apr. 7, 2003 and 60/469,672 filed May 12, 2003, the entire contents of which are incorporated by reference herein.

### FIELD OF THE INVENTION

The present invention relates to a painting container that is used as a painter's aid in holding both paint and paint brushes. The painting container can be held by a user by grasping a protruding handle assembly, or attached to the top of a stepladder.

### DESCRIPTION OF THE RELATED ART

It is well known that incorporating the correct tools for the job will make all the difference in the world in getting the job done properly and in a timely manner. The same is applied to the job of painting, whether it be for a homeowner, or for a commercial application. Having to carry around and paint from standard one or five gallon paint cans is not only a messy proposition but problematic. Large paint filled containers are often heavy and awkward to carry, especially if one is carrying heavy paint cans while climbing up or down a ladder.

Additionally, a full paint can will not allow one to wipe off any excess paint on the brush into the container without dripping it over onto the side of the can or having the excess paint work its way up the brush to the handle. Once on the painter's brush handle, the brush will often stick to the painter's hand, or the excess paint will drip to the floor.

Moreover, the typical paint containers are hard to carry around for any length of time due to their weight and design. For example, a typical single gallon paint can weighs over 8 pounds and this weight is distributed upon a thin wire handle. As a result, the thin wire handle of the typical paint container can dig into the painter's hand in a painful manner discouraging the painter from carrying the can. Painting directly from the paint can is also problematic when the level of the paint in the can is low, as it requires the painter to dip the brush deep into the bottom of the container and scrap the inner walls to fill the brush bristles with paint. This often results in the painter getting paint on their hands and clothing.

To address this need, painters routinely use containers such as paint trays. These trays commonly hold just one kind of paint or liquid and are typically designed to be used with a paint roller or applicator. These paint trays are large and heavy, often inhibiting the painter from holding the tray in one hand while painting. Oftentimes, the painter sets the paint tray on the ground or floor while painting which requires the painter to bend down to fill the roller or brush with paint and also makes painting less efficient. Moreover, the painter must periodically relocate the tray.

A further difficulty of using a painting tray for brush painting is that the paint tray does not provide a suitable place for positioning the brush when the painter is not painting. In particular, the painter often has to place the brush into the tray where the brush is in contact with wet paint. This can result in the brush being covered with paint which can result in the painter also getting their hands covered with paint. Moreover, the paint trays are also designed to hold only one color of paint or stain at a single time which requires the painter to clean the trays whenever the painter wishes to use the same tray to apply a different color of paint or stain.

To address these needs, variations of paint containers have been developed in the prior art. In particular, U.S. Pat. No. 4,164,299 to Fuhr, discloses a two compartment container developed to hold a liquid as well as a brush, and be held in the hand of the painter. While this patent discloses a two compartment container suitable for brush application of paint, stain and the like, the Fuhr device still has shortcomings. For example, the user must grasp the Fuhr device on a lip adjacent the upper edge of the container. The lip is difficult to hold, increasing the likelihood that the painter will inadvertently drop the container. Moreover, paint from the container may also get on the lip, making the lip more slippery and making the user's hands messy. Moreover, when the painter is using the Fuhr container and gets excess paint on the brush, there is no way to remove the excess paint from the brush in a manner that reduces the risk of dripping the excess paint onto the ground.

A further difficulty of the Fuhr container is that it can only be held in a painter's hand or rest on a surface where it may get tipped over. In many painting applications, it is necessary for the painter to use a ladder. The painter often has to use one hand to hold onto the ladder while using the other hand to grasp the paintbrush. Since the Fuhr container cannot be secured to the ladder, it must be simply rested on one of the ladder rungs. However, as ladders are often unstable during painting, this increases the risk that the container will fall off of the ladder onto the ground.

Other multi-compartment containers have been developed. For example, U.S. Pat. No. 4,706,918 to Wilson discloses a double compartment container that is adapted to be mounted onto a ladder. However, Wilson also does not provide a suitable handle for the user to grasp the container in one hand while painting with the other. Moreover, even though Wilson is designed to be mounted on a ladder, the container must be mounted over a rung which prevents the ladder from being positioned immediately adjacent a wall. Further, this design also inhibits mounting the Wilson container to the upper platform of a ladder.

A further difficulty of painting containers of the prior art, such as the Fuhr or the Wilson containers, is that the containers are typically adapted to be used with a single color of paint or stain. When the painter wishes to change from one color or shade to another, either a different container must be used or the previous container must be washed. This requires the painter to either purchase many duplicative containers or spend considerable time washing containers.

Another multi-compartment container is disclosed in U.S. Pat. No. 6,138,963 to Malvasio. Malvasio provides a container having a first compartment for receiving paint and a second compartment for receiving a paint brush. However, in order to store a paint brush in the second compartment of Malvasio, the brush must be stored vertically. This leaves two undesirable options, either the brush can be stored with the bristles of the paint brush facing downward, thus damaging the bristles, or the brush can be stored with the handle of the paint brush facing downward, thus allowing any paint that is on the bristles to drip downwardly onto the handle.

Yet a further difficulty that is experienced by painters is that once a painting container has been opened, there is often no practical way of resealing the container so as to preserve the freshness of the paint. This is a particular problem with the large five gallon paint cans that are commonly used today. Moreover, the smaller containers used by painters to carry smaller quantities of paint are often hard to store after use due to their small size and the fact that these containers are often coated with paint, stain and the like.

From the foregoing, it will be appreciated that there is a continuing need for a container that can be used to hold smaller quantities of paint, stain and the like. To this end, this container should be more portable, more easily mounted on ladders, allow for easy change from one shade of paint to another and also be easily stored.

### SUMMARY OF THE INVENTION

The aforementioned needs are satisfied by the paint container apparatus of the present invention which in one aspect consists of a main body that defines a first cavity and a second cavity, which extends from the upper lip of the main body. Each cavity respectfully defines a partially enclosed space wherein the first cavity is designed to receive and house a painting related tool during painting and wherein the second cavity is adapted to receive and store liquid during painting. Another possibility would be to store one type or color of paint, stain or the like in one cavity and another type or color of paint, stain or the like in the second cavity. A handle is attached to the main body wherein the handle has a shaft and the handle is attached so as to be adjacent the main body so that the shaft extends in a direction parallel to the first and second cavities.

In one aspect, the handle is dimensioned so as to permit a painter to grasp the handle in the palm of the painter's hand, thereby allowing the painter to carry the paint container in one hand from one location to another in a stable manner that inhibits spilling of the paint or liquid contained therein. In one embodiment, the handle serves a second purpose, and that being dimensioned so as to permit the handle to be positioned within a hole that exists in a top step of a common stepladder. In this embodiment, the main body is positioned adjacent an upper rung of a stepladder and the container is retained on the ladder by the combined interaction of the handle within the hole and the main body against the side of the ladder. This feature provides the painter a quick method for attaching and removing the container from the ladder.

Another aspect of the present invention further comprises a liner apparatus having a first cavity and a second cavity wherein the liner is dimensioned so that the first cavity of the liner is positioned within the first cavity of the main body of the container and can receive the painting related tool and so that the second cavity of the liner is positioned within the second cavity of the main body and can receive the paint during painting.

In one embodiment the liner assembly includes a roller section that extends out of the second cavity so as to define a generally planar surface that is adapted to receive a roller to facilitate the transfer of paint to a roller to thereby enable roller application of liquid stored in the second cavity to a surface to be painted. The quick attachment of the liner apparatus to the original container allows the painter the flexibility of now rolling the paint on the surface to be painted versus brushing.

Moreover, in another aspect, the present invention comprises a main body that defines a first cavity and a second cavity that extends from an upper lip of the main body in a first direction so that each cavity respectively defines a partially enclosed space wherein the first cavity is adapted to receive and store a painting related tool during painting and wherein the second cavity is adapted to receive and store liquid during painting. The upper lip of the main body defines a circular shape that matches and will mate to the opening of a paint container. The painting container of the present invention can thus be used as a reusable lid for other larger paint containers, such as a five or six gallon bucket through which large volumes of paint are often sold. In one embodiment, the reuseable lid has six equally spaced lift tabs attached to the outside diameter of the circular lid assembly by which the painter can separate by hand the lid from the paint container. In one embodiment, the reusable lid includes a plurality of different sealing flanges that engage with different sealing flanges on different larger painting containers so as to allow the container to be used to seal different types of containers.

From the foregoing, it will be appreciated that the painting container of the present invention provides a convenient container for carrying smaller quantities of paint in one hand. The container in one embodiment is well adapted for mounting on a ladder and can also be used, in another embodiment with disposable liners.

These and other objects and advantages of the present invention will become more fully apparent from the following description taken in conjunction with the accompanying drawings.

### BRIEF DESCRIPTION OF THE DRAWINGS

FIG. 1 is a perspective view of one embodiment of a paint container of the present invention;

FIG. 2 is a top view of the paint container of FIG. 1 illustrating the two distinct cavities, one used for receiving and storing a painting related tool and the other is adapted to receive and store paint;

FIG. 3 is a side, cross-sectional cutaway view of the paint container of FIG. 1;

FIG. 4 is an end view of the paint container of FIG. 1, further illustrating a handle assembly of the paint container;

FIG. 4A is a bottom view illustration of the paint container of FIG. 1 revealing the gusset reinforcements that extend from the handle assembly to the upper, outside edge of the second paint cavity;

FIG. 5 is a perspective view of the paint container of FIG. 1 demonstrating a manner of attaching a paint brush or related painting utensil to the paint container;

FIG. 6 is a side, cross sectional cutaway view of the paint container of FIG. 1, illustrating the stacking ability of the paint container;

FIG. 7 is a perspective view of the paint container of FIG. 1 attached to a typical step ladder;

FIG. 7A is a perspective view of an embodiment of FIG. 1 illustrating a single cavity container;

FIG. 8A is a perspective view of the paint container of FIG. 1 wherein a cavity liner is positioned on a paint container;

FIG. 8B is a perspective view of a liner assembly with an integral paint roller pan positioned on a paint container;

FIG. 8C is a perspective view of an embodiment of FIG. 8B illustrating a single cavity liner with integral roller pan positioned on a large paint container 100;

FIG. 8D is a cross sectional cutaway side view of the single cavity liner with integral roller pan, as illustrated in the upper embodiment of FIG. 8C;

FIG. 9A is a perspective view of the circular shaped paint liner designed to serve as a lid for a five gallon paint bucket;

FIG. 9B is a top view of the circular shaped paint container of FIG. 9A illustrating lift tabs at 6 places;

FIG. 9C is a side view of the circular shaped paint container of FIG. 9A used as a lid assembly for the five gallon paint bucket;

FIG. 9D is a bottom view of the circular shaped paint container of FIG. 9A illustrating a continuous inner sealing groove with 6 total sealing flanges;

FIG. 10A is a cross sectional cutaway side view of the inner sealing groove of FIG. 9D with sealing snap lock style A;

FIG. 10B is a cross sectional cutaway side view of the inner sealing groove of FIG. 9D with sealing snap lock style B.

FIG. 11 is a perspective view of a paint container according to an alternative embodiment of the invention, showing a grip disassembled from the paint container and a paint brush that may be received within a first cavity of the paint container;

FIG. 12 is a perspective view of the paint container of FIG. 11 showing the paint brush received within the first cavity of the paint container;

FIG. 13 shows a side view of the paint container of FIG. 11 showing the grip assembled to the paint container;

FIG. 14 is a bottom view of the paint container of FIG. 11 showing gusset reinforcements on an underside of the paint container; and

FIGS. 15A-15C shows various paint brushes that may be received within the paint container of FIG. 11.

### DETAILED DESCRIPTION OF THE PREFERRED EMBODIMENT

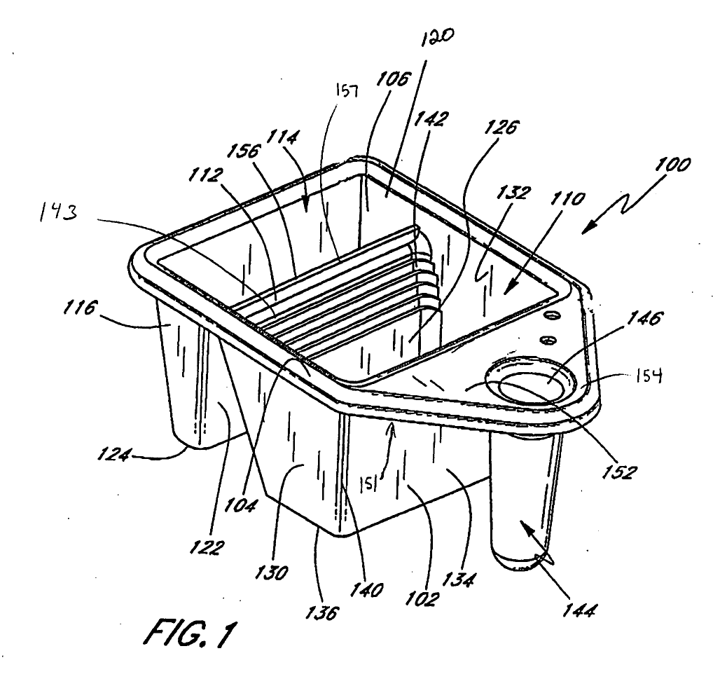

Reference will now be made to the drawings wherein like numerals preferred to like parts throughout. FIG. 1 illustrates one embodiment of a paint container 100. As illustrated in this embodiment, the paint container 100 is comprised of a main body 102 that is generally rectangular in shape that defines a first cavity 106 and a second cavity 110. Both the first cavity 106 and the second cavity 110 extend from an upper lip 104 of the main body 102 in a first direction so that each cavity respectively defines a partially enclosed space.

The shape of the first cavity 106 is wedgelike such that the width of the uppermost top of the first cavity 106 is the widest, narrowing down to a flat bottom surface 124. The first cavity 106 is comprised of a left side 116, a right side 120, a rear wall 114, a flat bottom 124, and a front wall 122. All four sides and bottom of the first cavity 106 meet together in a seamless, rounded manner which is characteristic of an injected molded product. The first cavity 106 and second cavity 110 are separated by the addition of a continuous folded divider 112 that forms an inverted-V shape that spans the entire width of the paint container 100. In one embodiment, such as that shown in FIG. 1, the top edge of container divider 112 is not flush with the paint container lip edge 104 allowing approximately one to two inches of overlap of the first cavity 106 and the second cavity 110 within the main body of the paint container 102. Hence, if a liquid were to completely fill the second cavity 110, it would eventually spill over into the first cavity 106 without overflowing the upper lip edge 104 of paint container 100 thereby reducing the amount of spillage of liquid onto the floor.

Hence, the divider 112 serves as an inner wall of the second cavity 110 also being adjacent to the inner wall of the first cavity 106 and defines a paint adjuster 142 that allows a user to remove excess paint from a brush in the manner that will be described in greater detail herein below. The paint adjuster 142 is comprised of a plurality of steps 143 that span the width of the paint container originating toward the upper edge of the container divider 112 and extending approximately 40% of the distance from the top edge of the container divider 112, downward to the flat bottom 136 of the second cavity 110. Each step height is approximately ¼ inch whereas the width is approximately 1/16 inch. The apex 156 of the container device 112 comprises a protruding edge 157 that further facilitates removal of excess liquid from a paint brush. Basically, excess liquid can be removed more easily from a paint brush by dragging the brush over the edge 157 and the edge of the stairs 143 such that the edges exert sufficient force to remove excess liquid from the bristles of the brush. Since the stairs 143 and the edge 157 are located below the upper edge 104 of the container 100, the likelihood of the excess paint removed from the brush spilling onto the ground is reduced as it generally will return to the second container 110.

The second cavity is also wedge-shaped whereas the width of the uppermost portion of the second cavity 110 is wider than where the rear wall 126 of the second cavity 110 intersects the flat bottom surface 136 of the second cavity 110. Perpendicular to the bottom surface 136 of the second cavity 110 is a front wall 134 of the second cavity 110 which also serves as the front side of the paint container 100. The second cavity 110 also includes left and right side walls 130 and 132. In the illustrated embodiment, all sides 140 and bottom surface 136 of the paint container 100 form a seamless transition from one component to the next as is the case with an injected molded product.

Extending out horizontally from the plane of the upper lip edge 104 of the paint container 100 is a triangular shaped panel 152. This triangular shaped panel 152 is perpendicular to the wall 134 of the second cavity 110 and attaches to the main body 102. In this embodiment of the paint container 100, the vertex 154 of this triangular shaped panel 152 encompasses a painter's handle assembly 144. The handle assembly 144 is attached in a perpendicular manner to a bottom side 151 of the triangular shaped panel 152 substantially adjacent the vertex 154 of the triangular shaped panel 152 of the main body 102 so as to extend perpendicularly outward therefrom.

As is shown in FIGS. 1-3, the handle assembly 144 extends outward from the panel 152 substantially the same distance as the bottom surfaces 136 of the container 100. Intone embodiment, the handle assembly 144 has a diameter of approximately 1.5 inches and is approximately 5 inches in length so as to allow a person to grasp the handle assembly 144 and wrap their fingers about the handle assembly 144 to thereby securely hold the container 100 in one hand. Hence, the container 100 allows the user to securely hold and carry the container with paint or other liquid stored in the second cavity 110 so as to permit application of the liquid to a wall in a well known manner. The length of the handle assembly 144, along with its diameter, decreases the likelihood that the user will drop the container 100 during use.

The first cavity 106 is adapted to receive and store a paint brush or other painting related article during painting wherein the second cavity 110 is adapted to receive and store liquid during painting. It will be appreciated that the container can be used to apply any liquid to a surface including paint, stain, or some other liquid treatment of a wall without departing from the spirit of the present invention.

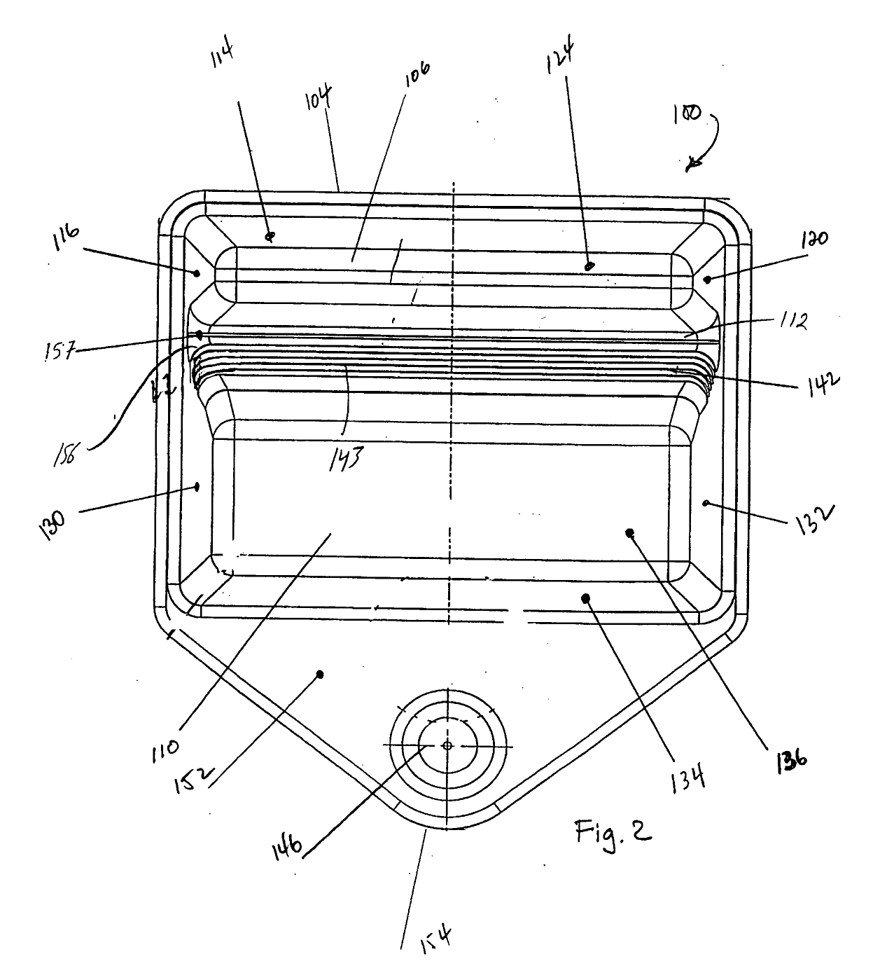

Referring now to FIG. 2, paint container 100 is shown in a top view. The first cavity 106 is shown separated from the second cavity 110 by use of the two walls of the divider 112 that spans the width of the cavities 106, 110. The stair-cased paint adjuster 142 can be seen being used as the angled inner wall of second cavity 110.

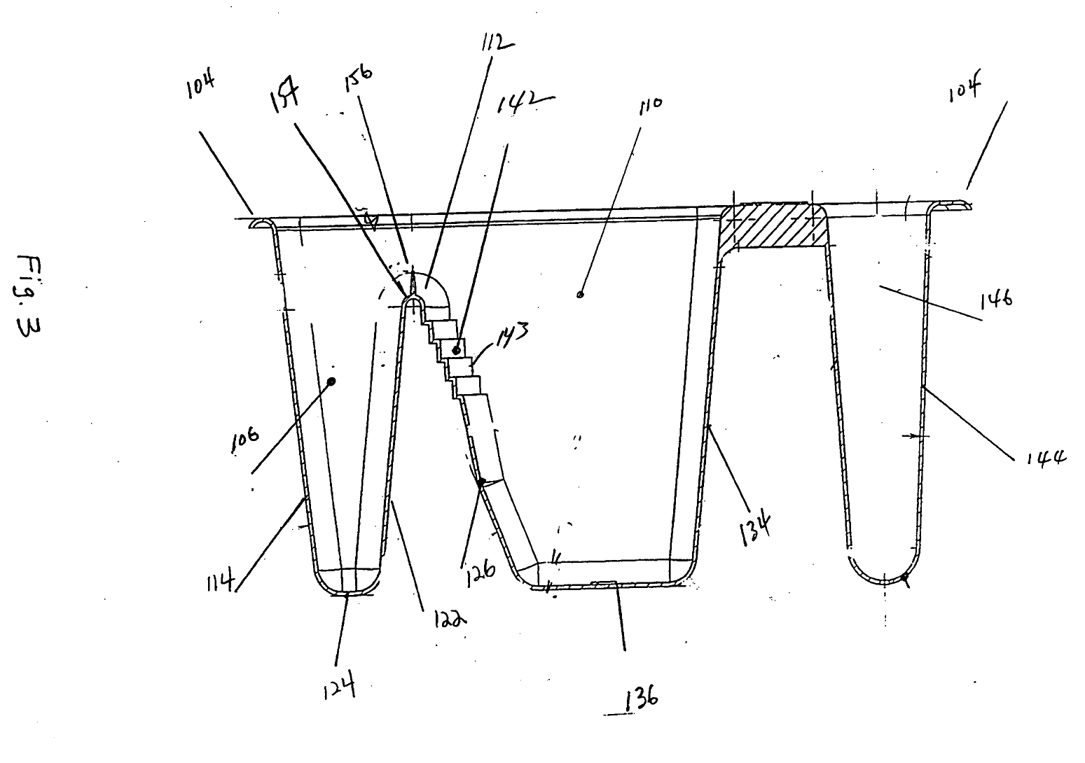

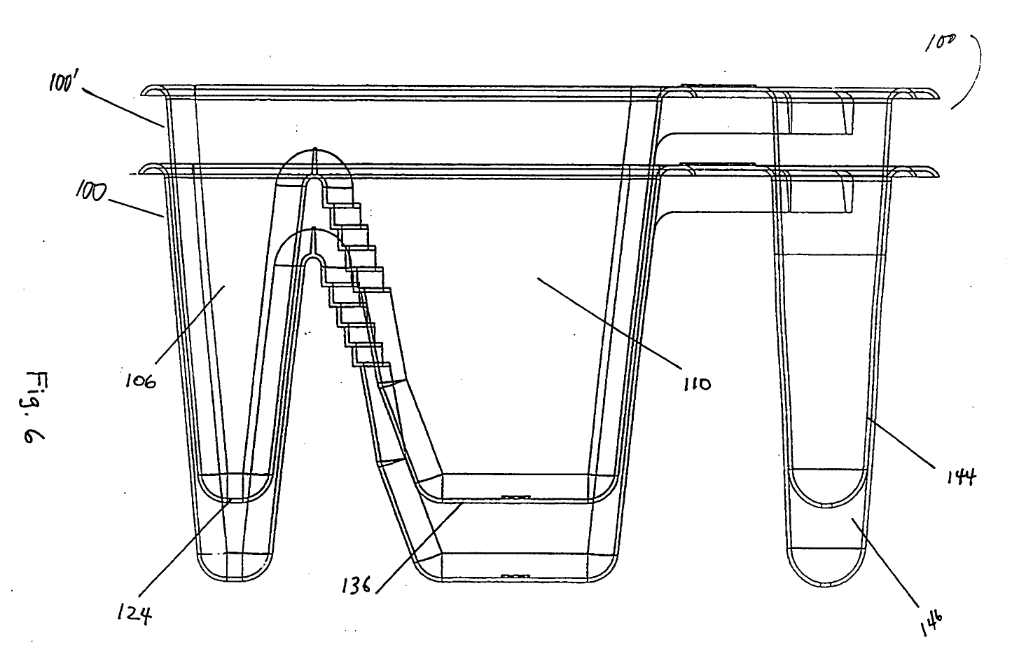

A cross sectional cutaway view of paint container 100 is illustrated in FIG. 3. The first cavity 106 can be seen to have less cross sectional area than the second cavity 110 and the overall volumetric capacity of the first cavity 106 is less than the second cavity 110. The inverted-V shape created by the front wall 122 of first cavity 106 and the rear wall of second cavity 126 that was discussed above is further illustrated in FIG. 3. As illustrated in FIG. 3, the interior portion 146 of the handle 144 is preferably hollow to permit stacking in the manner shown in FIG. 6. The upper lip 104 of the main body of container 100 is fully continuous around the perimeter, whereas this same upper lip 104 can be seen protruding over handle assembly 144, reducing the occurrence of paint dripping or splashing over onto the painter's hand. Another property of the continuous upper lip 104 is that it offers strength and rigidity to the entire paint container 100.

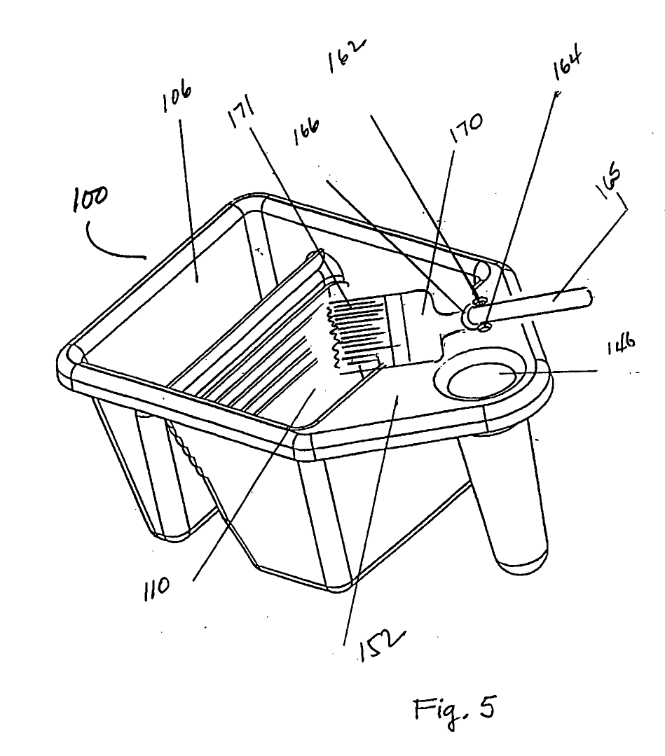

As described above, the staircased paint adjuster 142 of the second cavity 110 provides the painter a means of wiping off excess paint from the paint brush 170 (See, FIG. 5) or painting utensil. To wipe the excess paint off the paint brush, the painter will drag the brush along the staircased paint adjuster 142 in a vertical manner starting at the bottom edge of the container divider 112 and stroking the brush upward toward the top stair 143 of the divider 112, allowing the excess paint to wash down into the bottom of the second cavity 110. To remove excess paint from the paint brush 170, the painter will apply a force on the paint brush 170 perpendicular to the axis of the staircased paint adjuster 142 and a downward component of force against each step 143 of the plurality of excess paint adjusters 142 creating a scraping effect of the excess paint to flow off the paint brush bristles 171. Scraping the paint brush 170 against an otherwise flat cavity wall 126 would not produce the same enhanced paint removing or adjustment effect.

As discussed above, in embodiments where the top edge of container divider 112 is not flush with the paint container lip edge 104, it is less likely that paint will overflow the top of the second cavity 110 onto the floor during a refill of the paint container 100 by the painter. In particular, if a painter pours excessive paint or liquid into second cavity 110, the paint level will fill up second cavity 110 to a point such that the paint will gradually spill over the apex 156 of the cavity divider 112 and flow into the first cavity 106. The inherent nature of the container divider 112 height extending from the bottom of the paint container 100 to a height approximately 0.25 to 1.0 inches below the upper lip edge 104 of the paint container 100, requires the paint height to rise in both the first cavity 106 and second cavity 110 to a level greater than the upper lip edge 104 height before the paint begins to overflow on the floor or carpet.

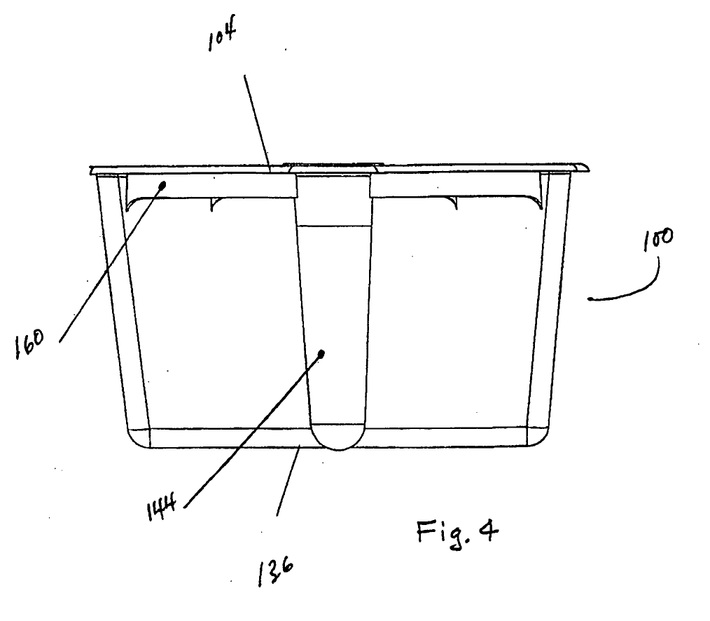

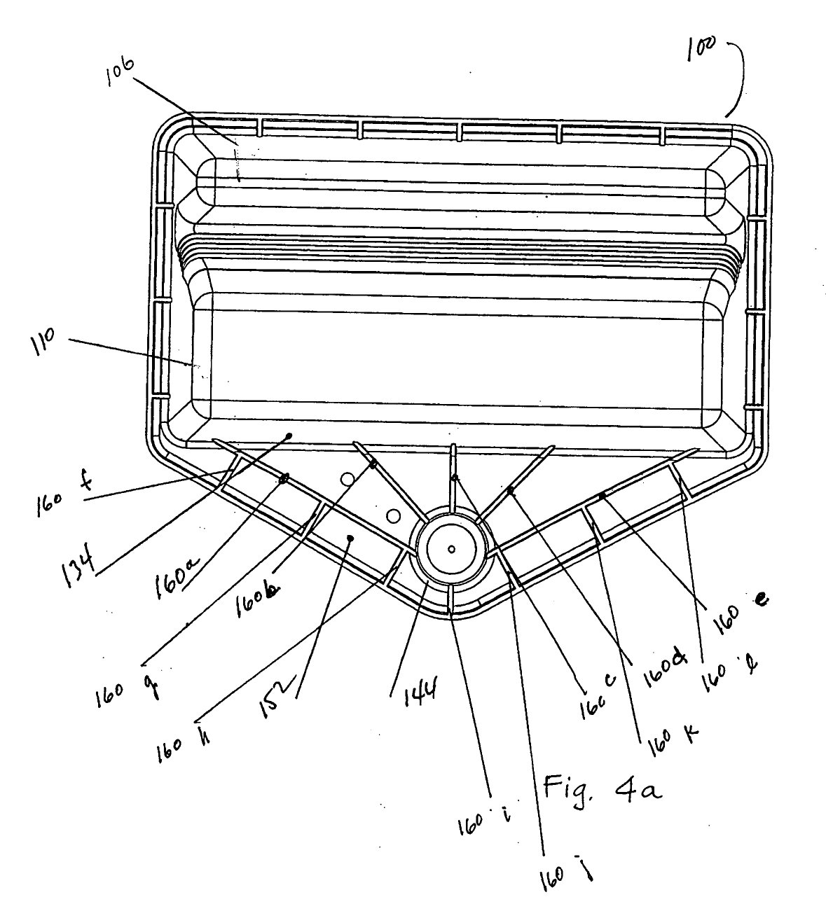

FIG. 4 is a right end view of the paint container 100 further illustrating the vertical handle assembly 144 that extends from the upper lip edge 104 to the floor or bottom of the second cavity 136. Gusset reinforcements 160 extend from the upper base of handle assembly 144 outward and underneath the triangular shaped panel 152 illustrated in FIG. 2 where they attach to the upper edge of a front wall of the second cavity 134.

The reinforcements 160 provide the paint container 100 rigidity so that the paint container can be safely carried by handle assembly 144 or attached to a stepladder without the container bending or flexing under the weight of the paint, allowing paint to spill out of the cavities. FIG. 4A is the bottom view of paint container 100 which further illustrates the reinforcing of the container 100. The reinforcements 160 extending along the triangular panel 152 emanate from handle assembly 144 and terminate at the upper edge of the front wall 134 of the second cavity 110. Moreover, the reinforcements 160 are attached to the wall 134 so that there is a continuous interconnection between the handle assembly 144 and the wall 134 of the cavity 110 so that there is a rigid interconnection between these two members. The reinforcements 160a through 160e form a geometry of plastic protrusions that radiate from the base of handle assembly 144 and extend horizontal and flush to the underside of triangular shaped panel 152. In addition, the reinforcements 160f through 160l attach in a perpendicular manner to the two radial reinforcement components 160a and 160ewherein these crossmember reinforcements 160f through 160l attach to the underside of the upper lip edge 104 of paint container 100. The reinforcements 160 in this embodiment are formed as a result of the injection molding process. In particular, channels are formed in the mold so that these channels can be filled with additional plastic material to define and provide the reinforcements 160.

The first positive physical effect of utilizing these reinforcements 160a through 160l is to reduce the bending that would occur along the upper edge of the front wall 134 of the second cavity 110 when a painter is carrying the paint container 100 by the handle assembly 144 and the liquid being positioned in the container 110 thereby reducing the possibility that liquid may spill from the cavities of the container 100. In addition, a second positive physical effect of utilizing reinforcements will keep the container from rocking while inserted and locked onto a step ladder.

Referring now to FIG. 5, one manner in which a painter's brush 170 or other painting utensil may be attached to the paint container 100 is illustrated. A retainer hole 162 and a retainer hole 164 are positioned in the triangular shaped panel 152 adjacent the hollow handle assembly 146. The retainer holes 162 and 164 are spaced apart approximately the width of the handle 165 of a paint brush 170. An elastic paint brush holder strap 166 extends between retainer holes 162 and 164 wherein the handle 165 of the paint brush 170 will fit securely under the elastic paint brush holder strap 166 such that the paint brush 170 will lay flush against the surface of the triangular shaped panel 152. The tightly drawn property of the elastic brush strap 166 provides it with a component of downward force perpendicular to the plane of the handle 165 of the paint brush 170 allowing the paint brush 170 to be securely held against the triangular shaped panel 152 of the paint container 100.

As shown in FIG. 5, the container 100 and the retainer holes 162, 164 are so positioned and so dimensioned that the elastic strap 166 engages with the handle 165 of the brush 170 so that the bristle portion 171 of the paint brush 170 is positioned such that the bristles 171 extend directly and completely over the enclosed space created by the second cavity 110, and in substantially the same plane as that of triangular shaped panel 152. This securing method allows the painter a method of temporarily storing a paint brush 170 or other painting utensil during painting without risking the brush bristles 171 from falling or dropping into the second cavity 110 and being submerged in the paint. Moreover, this mounting method provides a location for storing a used paint brush 170 in a manner that reduces the likelihood of the paint brush 170 dripping paint or other liquid onto the floor due to retainer holes 162, 164 and the retainer 166 being positioned to hold the paint brush 170 with the bristles 171 located over the cavity 110.

FIG. 6 is a cross sectional cutaway view of paint container 100. FIG. 6 illustrates the stacking feature of a paint container 100 on top of another identical second paint container 100′. As is illustrated in FIG. 6, the bottom surface 124 of the first cavity 106 and the bottom surface 136 of the second cavity 110 of the first container 100 are positioned within the first and second cavity 106, 110 respectively of the second container 100. Similarly, the handle assembly 144 of the first container 100 is positioned within the hollow opening 146 of the handle assembly 144 of the second container 100′. It will be appreciated that the stackable configuration of the containers 100 of the illustrated embodiment allows for more compact shipping and storage of the containers 100.

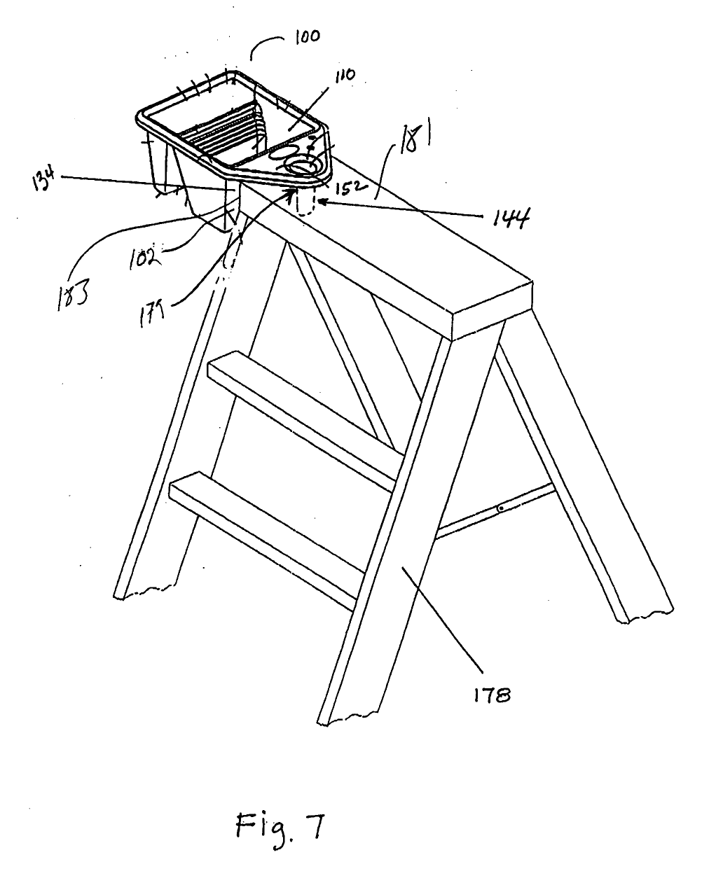

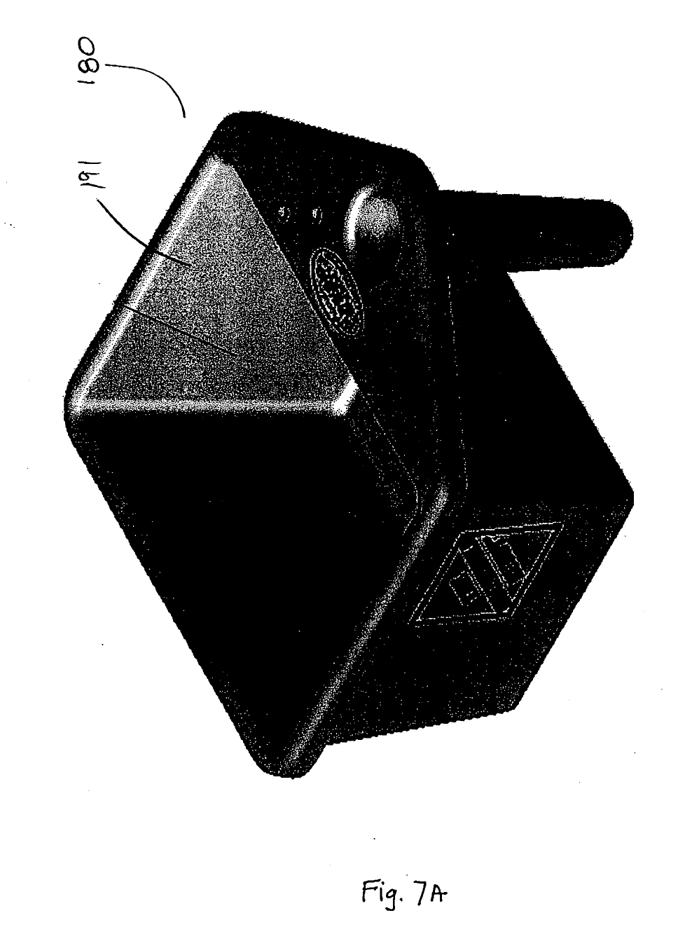

FIG. 7 illustrates the manner in which a paint container 100 is attached to a standard consumer or industrial stepladder 178. The paint container's handle assembly 144 shown with dashed lines is positioned within a hole 179 formed in the upper rung 181 of the stepladder 178 such that the main body 102 is positioned adjacent the upper rung 181 and the paint container 100 is retained on the ladder 178 by the combined interaction of the painter's handle 144 within the hole 179 and the main body 102 against the side of the ladder 178.

In particular, the triangle panel 152 and the handle 144 are dimensioned so that when the handle 144 is positioned within opening 179 in the ladder, the front wall 134 of the second cavity 110 is positioned adjacent a side wall 183 of the upper rung 181 of the ladder 178. The handle 144 is preferably sufficiently long and wide so as to engage with the inner walls of the opening 179 in the ladder to thereby inhibit rotation of the container 100 whereby the handle 144 would come out of the opening 179. Moreover, the engagement between the front wall 134 of the second cavity 110 and the sidewall 183 of the upper rung 181 further inhibits rotation of the container. Hence, the container 100 can be easily mounted on ladders, even when the container is full of liquid, and supported on the ladder without requiring the use of fasteners or complicated attachment mechanisms.

FIG. 7A illustrates another embodiment of a paint container 180 similar to the paint container 100 except that this container defines only a single cavity 191. This single cavity container 180 has a single cavity 191 to receive and store one type of paint or liquid during painting.

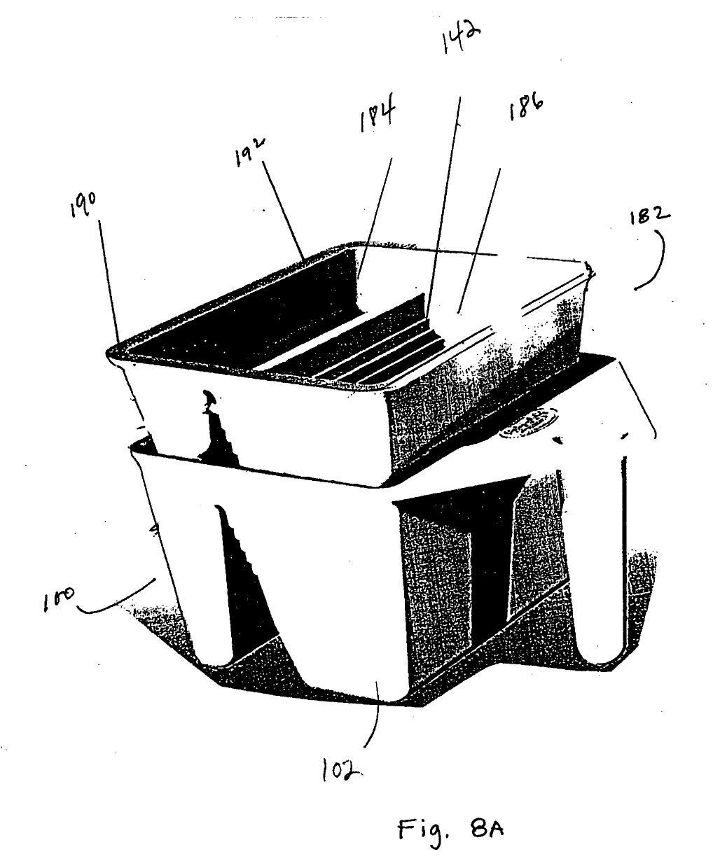

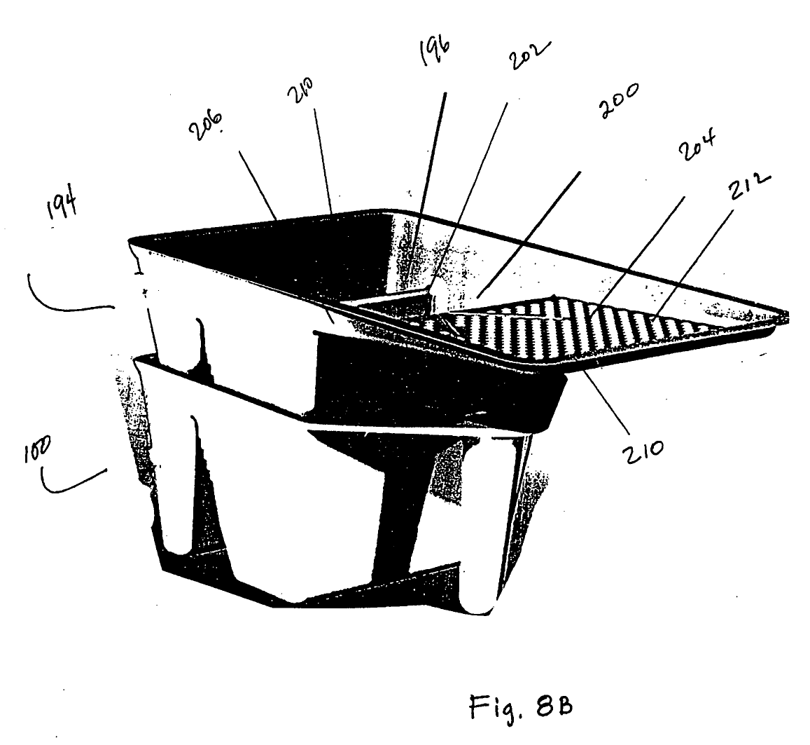

FIG. 8A illustrates another embodiment of paint container 100 with a first embodiment of a liner assembly 182. Similar to the paint container 100, the liner assembly 182 has a first cavity 184 and a second cavity 186 wherein the liner 182 is dimensioned so that the first cavity of the liner 184 is positioned within the first cavity 106 of the main body 102 and the second liner cavity 186 is positioned within the second cavity 110 of the main body 102. As with the paint container 100, the liner assembly 182 has a continuous upper lip edge 190 which is part of the liner main body 192 that extends downward in a first direction to form both the first cavity 184 and second cavity 186. The liner also has the characteristic excess paint adjuster 142 that is integral to the rear wall of the second cavity 126 of paint container 100.

Hence, in this embodiment, the liner 182 can be positioned within the cavities 106, 110 of the container 100 so as to line the container 100. The use of a liner 182 permits the container 100 to be used for application of different colors or textures of liquids without requiring significant cleaning of the container 100. Preferably, the liners are formed of an inexpensive material, such as vacuum formed or injection molded plastic, so that a user can purchase a single container with a plurality of liners so as to permit continuous reuse of the container 100.

The liner assembly 182 is also designed so that the first cavity 184 is adapted to receive and store a painting related tool during painting and wherein the second cavity 186 is adapted to receive and store paint or other liquid during painting. The liner assembly 182 is designed for disposability allowing for convenience in cleanup.

FIG. 8B represents another embodiment of the paint container 100 having a liner assembly 194 that incorporates an integral roller pan 194. In this embodiment, the liner 194 with integral roller pan 194 has a first cavity 196 and a second cavity 200 wherein the liner is dimensioned so that the first liner cavity 196 is positioned within the first cavity 106 of the main body 102 and the second liner cavity 200 is positioned within the second cavity 110 of the main body 102. As with the liner assembly 182 from FIG. 8A, the liner with integral roller pan 194 has a continuous upper lip edge 210 that extends downward in a first direction to form both the first cavity 196 and second cavity 200. The first cavity 196 is separated from the second cavity 200 by a liner divider 202.

The liner with integral roller pan 194 incorporates a roller pan 204 that extends outward in a horizontal direction from second cavity 200. The roller pan 204 surface is, in this embodiment, at a height of approximately 1 inch below the upper surface of the lip edge 210 of the liner. The roller pan 204 has a slight angled bottom 206 that angles toward the outer wall of the second liner cavity 200 to allow excess paint to return to the cavity 200. In addition a dimpled surface 212 extends the entire length of this roller pan 204. The dimpled surface 212 consists of a matrix of ⅜ inch diameter bubbled protrusions in the floor or bottom surface of the roller pan 204 of the liner with integral roller pan 194. Each dimple of the dimpled surface 212 protrudes approximately 1/16 to 1/18 inch from the surface of roller pan 204.

The liner with integral roller pan 194 is used in combination with a paint roller for the purpose of rolling paint or liquid onto a wall or ceiling or other surface. The dimpled surface 212 of the roller pan 204 provides the paint roller a slight desirable frictional effect in adjusting the amount of paint that the painter has applied to the roller from second liner cavity 200. A painter's roller is dipped into the second liner cavity 200 and the paint or liquid contained therein is rolled along the dimpled surface 212 of roller pan 204 wherein the paint is squeezed onto the roller surface with even force and a uniform distribution of paint.

The downward sloping nature of the angled pan bottom 206 of the roller pan 204 is illustrated in FIG. 8B. There is a gradual slope of the roller pan 204 such that the dimpled surface 212 originates at the upper edge of the second liner cavity 200 approximately 1.0 inch below the surface of the liner upper lip edge 210 and extends outward in a horizontal fashion to the edge of roller pan 204 approximately 0.5 inch below the liner upper lip edge 210. All seams and adjoining partitions of the liner with integral roller pan 194 are continuous with an absence of sharp edges due to the nature of the injected molding process. The slight slope created by the height differential of 0.5 inch over a total length of 7.0 inch horizontal roller pan 204 provides a means for excess paint to wash down into the second liner cavity 200.

Referring now to FIG. 8C, the manner in which a single cavity liner with integral roller pan can be used with the paint container 100 is illustrated. The single cavity liner with integral roller pan 214 is an embodiment of the liner with integral roller pan 194 illustrated in FIG. 8B. In this embodiment, the single liner cavity 215 of the single cavity with integral roller pan 214 apparatus is inserted into the second cavity 110 of the paint container 100. The single cavity liner with integral roller pan 214 exhibits the same paint adjuster 142 as illustrated in FIG. 8A. In some circumstances, it is easier to manufacture a single cavity liner as opposed to a two cavity liner in a vacuum form process due to the thinning of the material. Hence, it will be appreciated that the present invention contemplates both a single and a double cavity liner without departing from the spirit of the present invention.

FIG. 8D illustrates a cross sectional cutaway side view of the single cavity liner with integral roller pan 214, further detailing the dimpled surface 212 of the roller pan 204. The single liner cavity 215 has the same characteristic wedgelike shape as described for FIG. 1 for the second cavity 110 of the paint container 100.

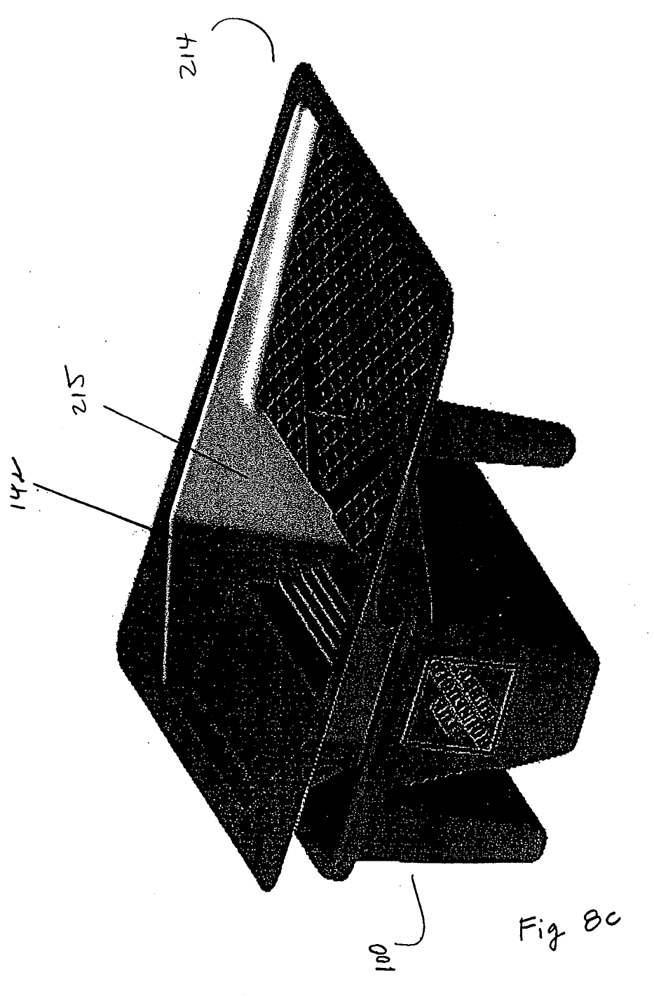

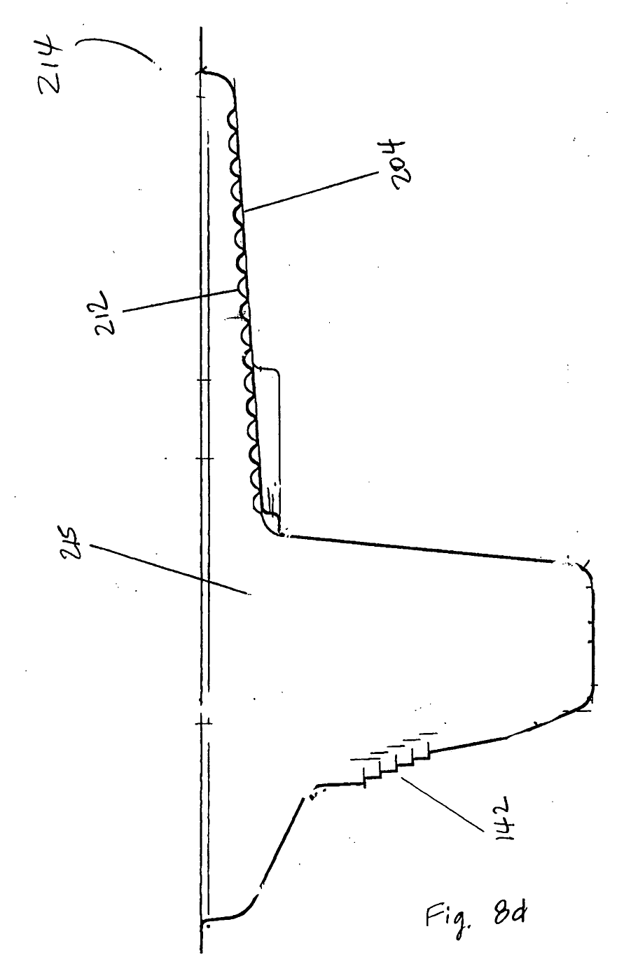

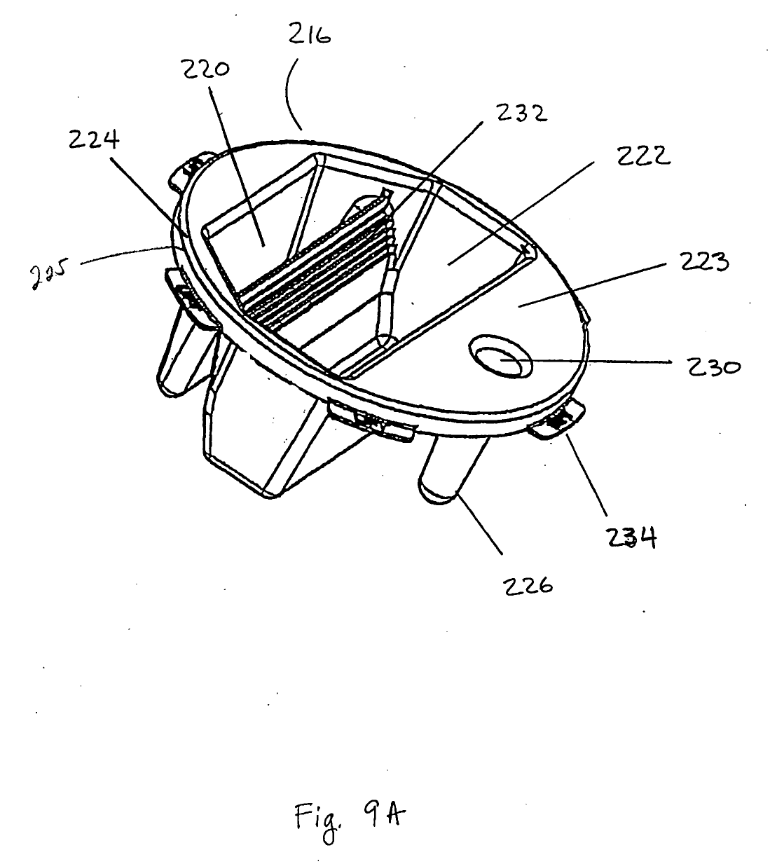

FIG. 9A demonstrates another embodiment of a paint container according to the present invention, wherein the circular shaped apparatus represents a five gallon paint container 216. The paint container 216 defines a first cavity 220 and a second cavity 222 that extends from an upper surface 224 of the paint container in a first direction so that each cavity respectively defines a partially enclosed space. A handle is attached to the container 216 wherein the handle has a shaft 226 and the handle is attached so as to be adjacent the bottom side of the container so that the handle extends in a direction parallel to the first cavity 220 and the second cavity 222. A semi-circular shaped flap 223 extends horizontally from the second cavity 222 and surrounds as well as retains handle assembly 226. The handle assembly 226 is hollow 230 for the five gallon liner assembly 216 as was the case for the paint container 100 illustrated in FIG. 1. The inner wall of the second liner cavity 222 serves as the excess paint adjuster 232.

The first cavity 220 is adapted to receive and store a paint brush or other painting related utensil during painting and the second cavity 222 is adapted to receive and store paint during the painting process in the same manner as described above.

As illustrated in FIGS. 9A and 9B, the container 216 defines a circular surface 225 with the cavities 220 and 222 being formed therein. The outer edge of the circular surface 225 defines a continuous circular lip 225 that is adapted to be used to position the container 216 on the top of a typical paint container such as a five gallon paint bucket so that the container 216 can be used both for the application of paint and also for preserving the freshness of unused paint.

As is illustrated in FIGS. 9A-9D, the lip 224 defines a recess 236 that is to receive an upper lip 235 of the container 240. Preferably, the recess 236 is sized so as to sealably mate with the upper lip bead 235 of the container 240. A plurality of lift tabs 234a-234f are spaced about the outer perimeter of the painting container to facilitate removal of the painting container from the container 240.

The seal 224 is also configured to also allow the container 216 to be locked to a plurality of different five and six-gallon paint buckets. Five and six gallon paint buckets generally include an indentation 241 formed adjacent the upper edge 240 of the bucket. The indentations are generally positioned at several different heights on the lip 240. In fact, there are two standard configurations of bucket lips with indentations 241, 241′ formed at different locations. The container lid 216 is designed so as to be securely mounted to buckets having either of the two standard configurations. In particular, protrusions 246 and 244 are formed into the interior of the lip 236 at locations adjacent the tabs 234a-234e. In particular, as illustrated in FIG. 9D, the protrusions 246 and 244 alternate around the entire perimeter of the lip 236.

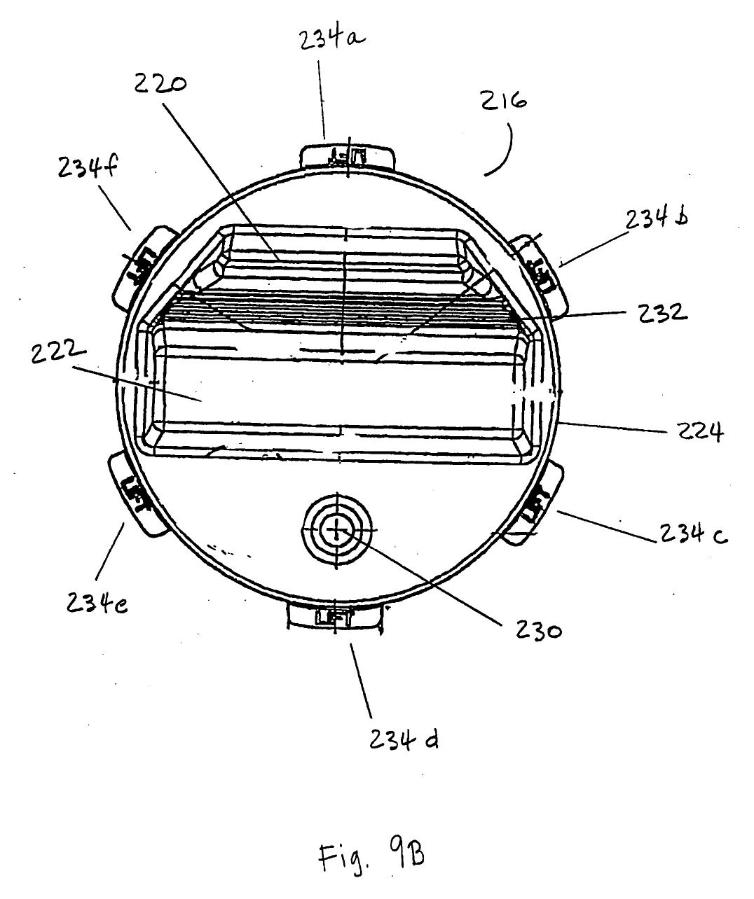

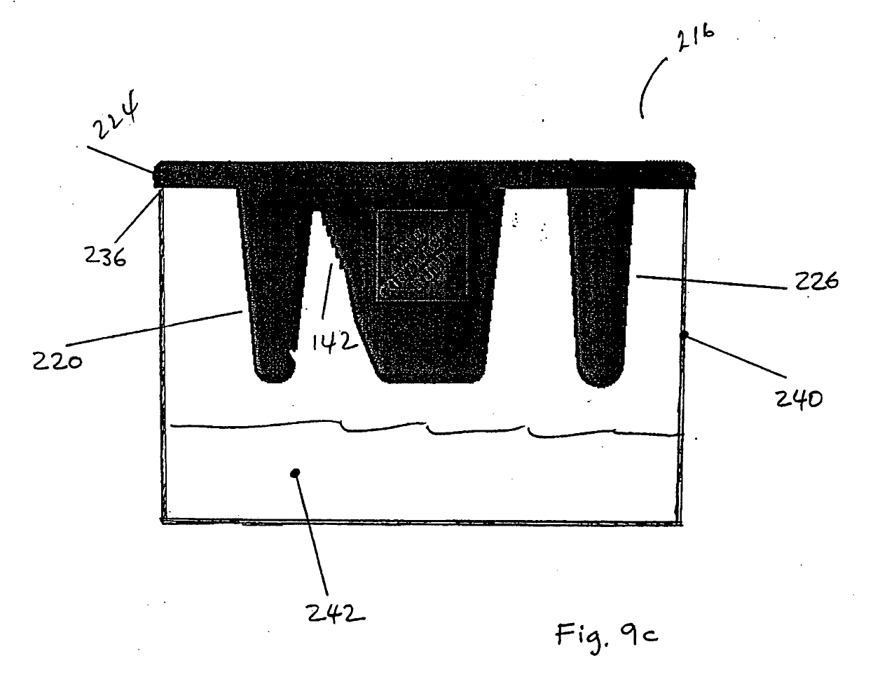

As illustrated in FIGS. 10A and 10B, the lips selectively engage with the indentations 241 on the exterior surface of the upper lip 240 of the paint bucket. As there are a total of six indentations, the container will be coupled to the bucket at at least three points thereby securely retaining the container to the paint bucket 240.

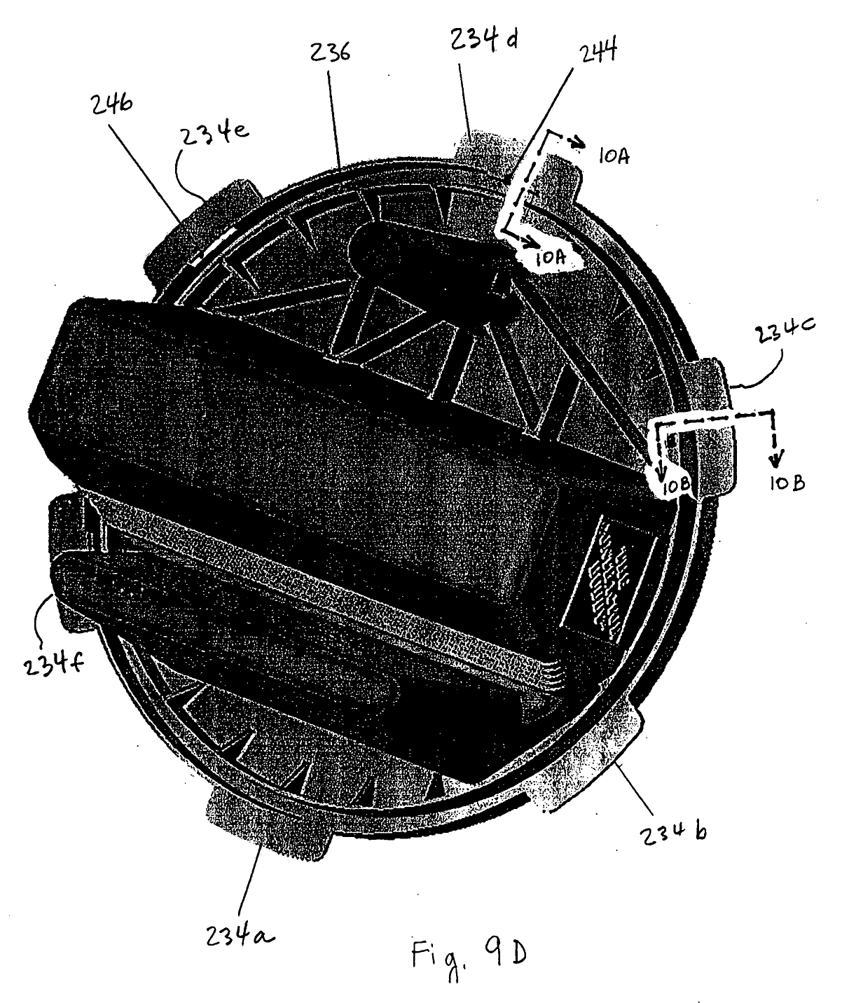

FIGS. 11-14 show a paint container 101 according to another embodiment of the invention. The paint container 101 of FIGS. 11-14 includes the main body 102, the upper lip 104, and the first and second cavities 106 and 110 as described above. The first cavity 106 includes the left side wall 116, the right side wall 120, the rear wall 114, the flat bottom 124, and the front wall 122. However, whereas in the embodiment depicted in FIG. 1, the walls 116; 122; 120; 114; and 124 combine to form a continuous partially enclosed structure, in the embodiment of FIGS. 11-14, the side walls 120 and 116 each define a longitudinal slot 103.

The longitudinal slots 103 allow the paint brush 170 to be inserted longitudinally into the first cavity 106, such that the handle 165 of the brush 170 protrudes from the first cavity 106 through one of the slots 103 and one of the side edges 105 of the brush 170 rests against the bottom wall 124 of the first cavity 103. As a result, in the embodiment of FIGS. 11-14, the brush 170 does not encounter some of the problems associated with supporting the brush vertically in the first cavity 106, such as damaging the bristles 171 (which may occur when the brush 170 is vertically supported with the bristles 171 resting against the bottom wall 124) or allowing paint to drip from the bristles 171 to the handle 165 (which may occur when the brush 170 is vertically supported with the handle 165 resting against the bottom wall 124). In addition, allowing the handle 165 to protrude from the first cavity 106 through one of the slots 103 facilitates removal when it is desired to remove the paint brush 170 from the first cavity 106.

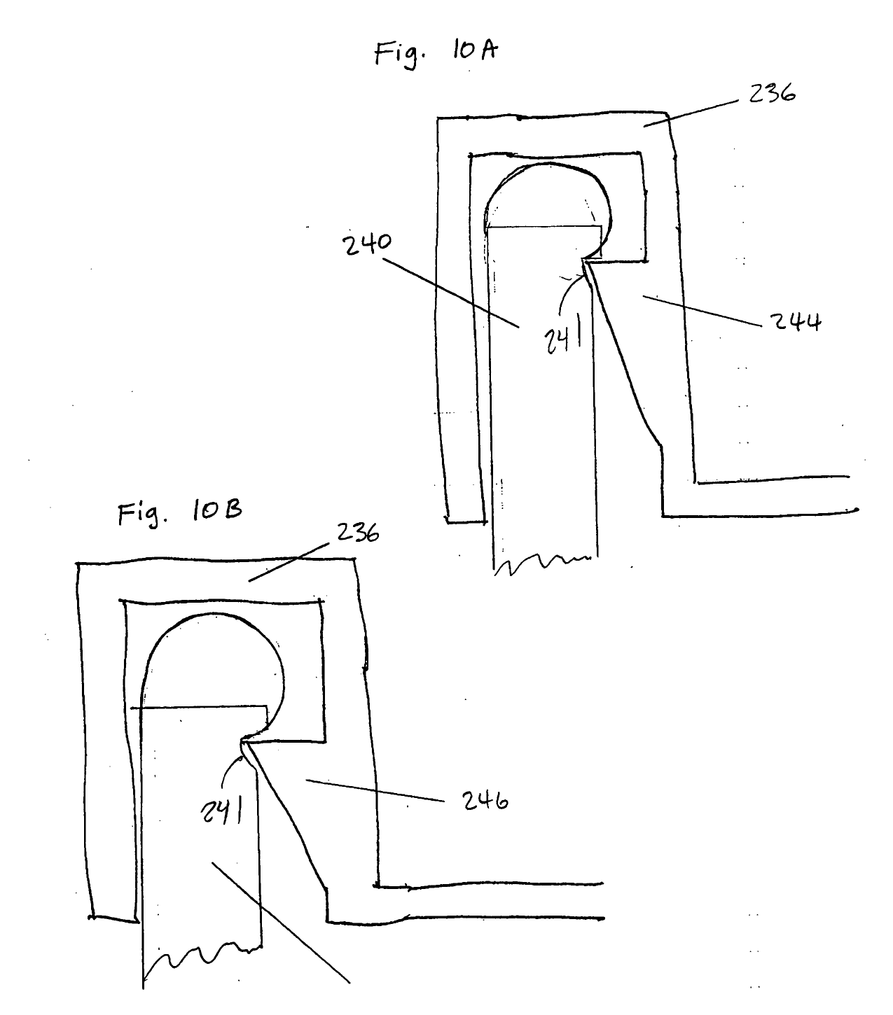

The longitudinal slots 103 may extend from the upper lip 104 to the bottom wall 124 of the first cavity 106 or the slots 103 may extend from the upper lip 104 to a position in proximity to the bottom wall 124, leaving a side lip 107 as shown, for example, in FIG. 12. In such an embodiment, the side lip 107 may engage a portion of the juncture 109 of the brush bristles 171 and the brush handle 165 to prevent the brush 170 from being longitudinally dislodged from the first cavity 106 when the brush 170 is longitudinally disposed in therein. The side lip 107 also provides a small reservoir to capture paint that drips off of the brush 170.

Although FIGS. 11-14 show longitudinal slots 103 in the left and right side walls 116 and 120, in an alternative embodiment only one of the side walls 116 or 120 includes the longitudinal slot 103. In other alternative embodiments, one or both of the side walls 116 and 120 are omitted such that a spacing exists between the front and rear walls 122 and 114. In such an embodiment, when the brush 170 is longitudinally disposed in the first cavity 106, the brush handle 165 is allowed to protrude from the first cavity 106 through the spacing between the front and rear walls 122 and 114.

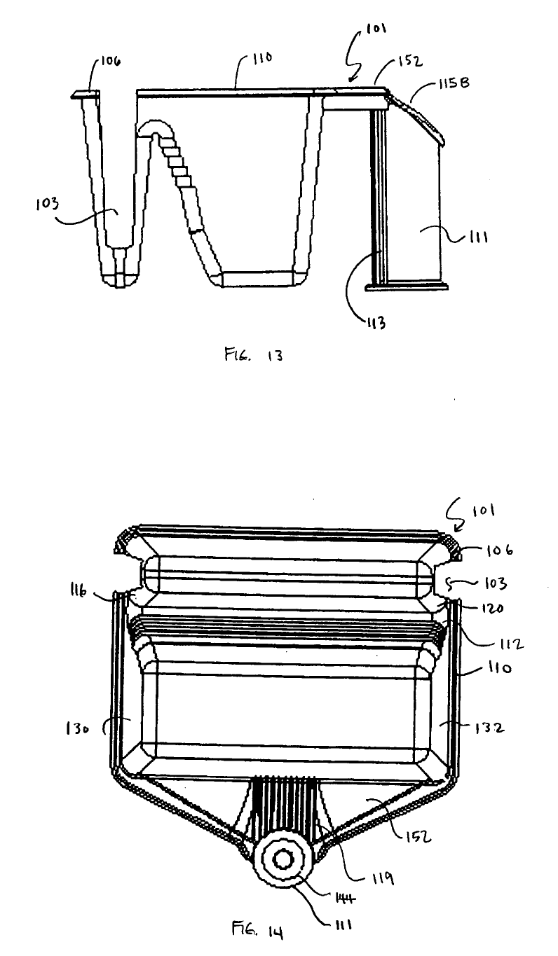

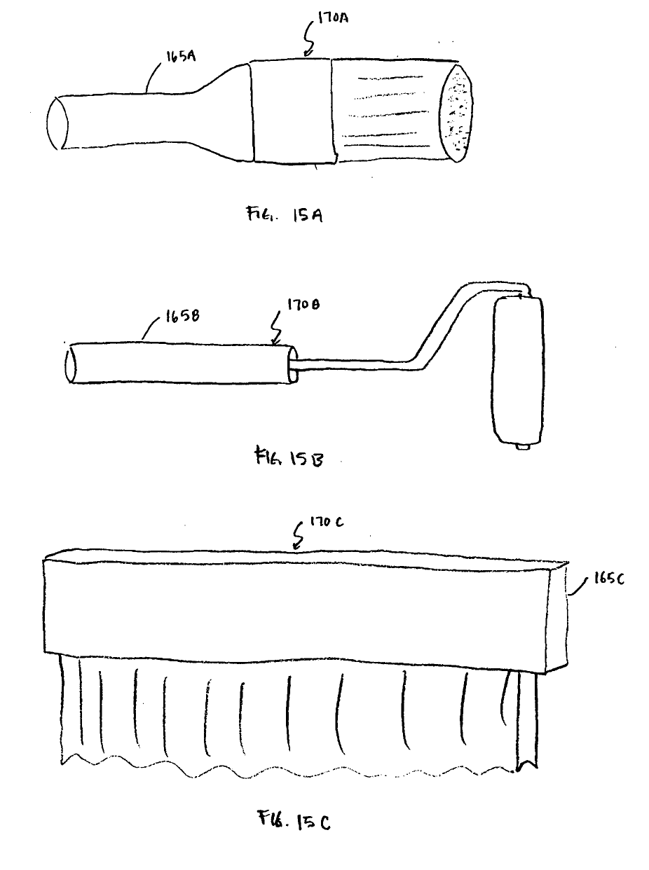

FIGS. 11 and 12 show a conventional paint brush 170 for insertion into the first cavity 106 of the paint container 101, however, other types of paint brushes or applicators may be used with the paint container 101 as described above, such as a circular brush 170A (FIG. 15A), a roller 170B (FIG. 15B), or a rectangular brush 170C (FIG. 15C), among other suitable brushes. When a circular brush, such as that shown in FIG. 15A, is disposed in the first cavity 106 of the paint container 101, the longitudinal slots 103 allow the handle 165A of the circular brush 170A to extend therethrough as described above. Similarly, when a roller, such as that shown in FIG. 15B, is disposed in the first cavity 106 of the paint container 101, the longitudinal slots 103 allow the handle 165B of the roller 170B to protrude therethrough. The slots 103 do not provide the same advantage when a rectangular brush, such as that shown in FIG. 15A, is disposed in the first cavity 106 of the paint container 101. However, the first cavity 106 is designed to substantially enclose the rectangular brush 170C when it is disposed in the first cavity 106.

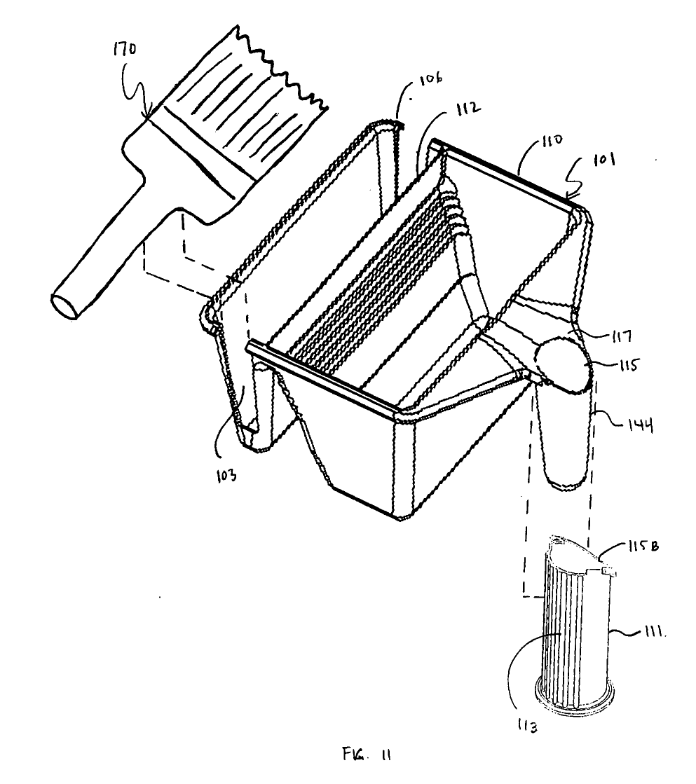

FIG. 11 shows in a disassembled state and FIG. 13 shows in an assembled state a grip 111 for attachment to the handle assembly 144. The grip 111 may be fixedly attached to the handle assembly 144, such as by an adhesive or another appropriate means, or the grip 111 may be removably attached to the handle assembly 144. In either event, the grip 111 at least partially encloses the handle assembly 144. The grip 111 may be composed of a soft material, such as rubber or foam. As such, the grip 111 increases the comfort to a user that holds or carries the paint container 111 by the handle assembly 144.

The grip 111 may also include a recessed portion 115B in an upper end thereof that corresponds to a truncated portion 115 in an upper end of the handle assembly 144. The handle assembly 144 may also include a recessed channel 117 adjacent to the recessed portion 115 of the handle 144. The truncated portion 115, the recessed portion 115B and the recessed channel 117 ergonomically receive the thumb of a user to further increase comfort to the user when the user holds or carries the paint container 111 by the handle assembly 144. The grip 111 may also include ridges 113 to facilitate grasping by the user.

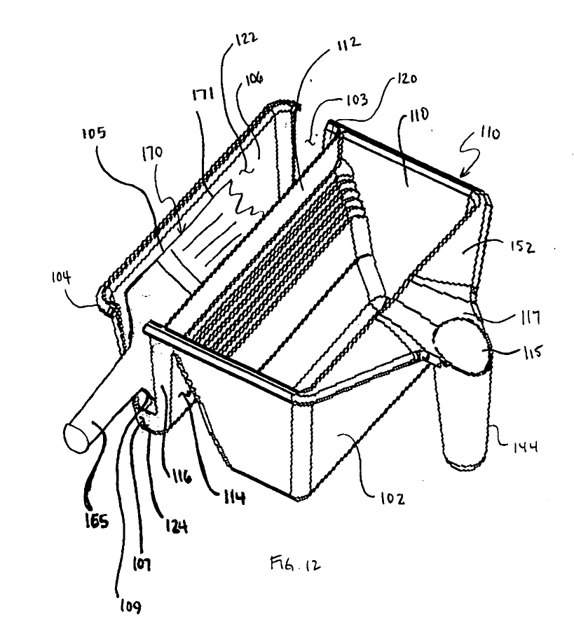

FIG. 14 shows gusset reinforcements 121 formed on the underside of the triangular shaped panel 152 as described above. In the embodiment of FIG. 14, the reinforcements 121 are formed substainally parallel to each other and to the side walls 116 and 120 of the first cavity 106 and the side walls 130 and 132 of the second cavity 110. The parallel configuration of the reinforcements 121 increases the ease and time efficiency of forming the paint container 101 by an injection molding process. The reinforcements 121 may also be sufficiently closely spaced as shown in FIG. 14 to provide a user with the sensation of a substantially flat surface when the user's hand is pressed against the reinforcements 121.

As shown in FIGS. 11 and 12, the divider 112, as described above, has a top edge that is substantially flush with the paint container lip edge 104. In each of the embodiments described above, the divider 112 can be formed such that its top edge is substantially flush with the paint container lip edge 104 or such that its top edge is in proximity to but not flush with the paint container lip edge 104. Either position of the divider 112 is acceptable, the trade-off being that when the divider 112 is flush with the paint container lip edge 104 the volumetric capacity of fluid that can be contained within the second cavity 110 is increased and when the divider 112 is in proximity to but not flush with the paint container lip edge 104 overflowing or spilling of the fluid contained within the second cavity 110 is less likely since when the second cavity 110 is filled to capacity, fluid overflows over the top edge of the divider 112 and into the first cavity 106 before it overflows over the lip edge 104 and out of the paint container.

It will be appreciated from the foregoing description that various embodiments of a painting container suitable for applying paint or any other sort of liquid to a surface such as walls, ceilings, fences, and the like, is provided. The painting container includes a handle and at least one recess that is adapted to receive paint or other liquid. The container also preferably includes a second recess that is suitable for storing brushes and the like. The painting container can be configured to receive inserts that can be disposable thereby reducing the need to clean the container. Moreover, the container can also be contoured so as to mount to a paint bucket to thereby also serve the function of a lid of the paint bucket.

Although the foregoing description of the preferred embodiment of the present invention has shown, described and pointed out the fundamental novel features of the invention, it will be understood that various omissions, substitutions, and changes on the form of the detail of the apparatus as illustrated as well as the uses thereof, may be made by those skilled in the art without departing from the spirit of the present invention. Consequently, the scope of the present invention should not be limited to the foregoing discussions, but should be defined by the appended claims.

What is claimed is:

1. A container for painting:
a main body that defines a first cavity and a second cavity that extends from an upper lip of the main body in a first direction so that each cavity respectively defines a partially enclosed space wherein the first cavity is adapted to receive and store a painting related tool during painting and wherein the second cavity is adapted to receive and store liquid during painting; and
a handle attached to the main body wherein the handle has a shaft and the handle is attached as to be adjacent the main body and so the shaft extends in a direction parallel to the first and second cavities.

2. The container of claim 1, wherein the shaft is dimensioned so as to permit a user to grasp the shaft in the palm of a user's hand.

3. The container of claim 1, wherein the handle is attached to the shaft so that the shaft is spaced a first distance from the main body and wherein the shaft is sized so as to permit the shaft to be positioned within an opening in a ladder such that the main body is positioned adjacent an upper rung of the ladder and the container is retained on the ladder by the combined interaction of the shaft within the hole and the main body against the side of the ladder.

4. A painting container comprising:
a main body that defines a first cavity and a second that extends from an upper lip of the main body in a first direction so that each cavity respectively defines a partially enclosed space wherein the first cavity is adapted to receive and store a painting related tool during painting and wherein the second cavity is adapted to receive and store liquid during painting; and
a liner having a first cavity and a second cavity wherein the liner is dimensioned so that the first cavity of the liner is positioned within the first cavity of the main body and can receive the painting related tool and so that the second cavity of the liner is positioned within the second cavity of the main body and can receive the paint during painting.

5. The container of claim 4, further comprising a handle attached to the main body wherein the handle has a shaft and the handle is attached so as to be adjacent the main body and so that the shaft extends in a direction parallel to the first and second cavities.

6. The container of claim 4, wherein the liner includes a roller section that extends out of the second cavity so as to define a generally planar surface that is adapted to receive a roller to permit roller application of paint stored in the second cavity to a wall.

7. A container for painting comprising:
a main body that defines a first cavity and a second cavity that extends from an upper lip of the main body in a first direction so that each cavity respectively defines a partially enclosed space wherein the first cavity is adapted to receive and store a painting related tool during painting and wherein the second cavity is adapted to receive and store liquid during painting; and
a handle attached to the main body wherein the handle has a shaft and the handle is attached so as to be adjacent the main body and so that the shaft extends in a direction parallel to the first and second cavities and wherein the handle has an upper lip and wherein the upper lip of the handle and the upper lip of the main body are contoured so as to define a first shape that is adapted to cover a separate paint container.

8. The container of claim 7, wherein the first shape defined by the upper lips of the main body and the handle is a circle that matches the circular opening of a cylindrical paint container.

9. The container of claim 8, wherein the circular edge of the main body has equally spaced lift tabs for the convenience of removing the liner assembly from a five gallon paint container without the use of tools.

10. The container of claim 8, further comprising two distinct shaped sealing flanges, wherein one sealing flange is located under each lift tab, and the flange style alternates in pattern between any two adjacent lift tabs.
